(19) United States
(12) Patent Application Publication
(10) Pub. No.: US 2026/0050422 A1
(43) Pub. Date: Feb. 19, 2026

(54) Extraction Script Generation

(71) Applicant: Maplebear Inc., San Francisco, CA (US)

(72) Inventors: Riddhima Sejpal, Dublin, CA (US); Jatin Jain, Issaquah, WA (US); Lily Sierra, San Francisco, CA (US); Aomin Wu, Scarsdale, NY (US); Jiankun Song, New York, NY (US); Monta Shen, New York, NY (US)

(21) Appl. No.: 19/298,928

(22) Filed: Aug. 13, 2025

Related U.S. Application Data
(60) Provisional application No. 63/683,612, filed on Aug. 15, 2024.

(51) Int. Cl. G06F 8/35; G06F 16/955

(52) U.S. Cl. CPC G06F 8/35; G06F 16/9566

(57) ABSTRACT

An online system may include a multi-agent code generator that receives webpage data describing a webpage with target content, identifies the target content by analyzing the structure of the webpage, and generates a script configured to extract the target content. The online system can execute the script to extract the target content and store the extracted data in a database for later access by the online system. For example, a chatbot of the online system can reference the stored data describing the target content to generate a response to a query.

### CROSS REFERENCE TO RELATED APPLICATION

This application claims the benefit of U.S. Provisional Application No. 63/683,612, filed on Aug. 15, 2024, which is incorporated by reference herein in its entirety.

### BACKGROUND

Some online systems provide Large Language Model (LLM)-based chatbot systems that can respond to user requests or questions. The online system may refer to or access a corpus of data (e.g., webpages and documents) that include information for providing helpful responses to users. However, many webpages that online systems use to respond to user requests contain significant amounts of irrelevant information that can confuse the chatbot system and thus result in incorrect or improper responses. For example, a webpage may include side links that are not directly related to the main content of the page and thus confuse the chatbot system. An LLM can be prompted to identify or extract relevant information on a webpage that may be useful to the chatbot system (e.g., the main content of the webpage). However, LLMs are ineffective for use in this context as their outputs for these prompts are prone to hallucinations.

### SUMMARY

In accordance with one or more aspects of the disclosure, an online system includes a multi-agent code generator that receives webpage data describing a webpage with target content, identifies the target content by analyzing the structure of the webpage, and generates a script configured to extract the target content. The online system can execute the script to extract the target content and store the extracted data in a database for later access by the online system. For example, a chatbot can reference the stored data describing the target content to generate a response to a query.

The multi-agent code generator is a multi-agent system that interfaces with one or more large language models (LLMs). For example, the multi-agent code generator includes a content analysis agent and a code generation agent. The content analysis agent can generate a prompt for an LLM that includes the webpage data and instructions to analyze the webpage data to determine the (e.g., HTML) structure of the webpage and to identify target content of the webpage based on the structure. The code generation agent can generate a prompt for an LLM that includes (a) the determined structure and identified content from the content analysis agent and (b) instructions to generate a (e.g., Python) script that, when executed, extracts the identified target content from the webpage. The multi-agent code generator may also include a critique agent configured to evaluate the output of each agent and provide feedback if an output fails an accuracy determination (via prompt generation and input to an LLM), thus improving the operation and accuracy of the content analysis agent and a code generation agent.

Overall, the generation and execution of a script to extract target content from a webpage improves the technical field of targeted data extraction by leveraging programmatic extraction to achieve greater content extraction accuracy and consistency and reduce LLM hallucinations. Said differently, a script is more effective at extracting target content (and not extracting unimportant information, which may be near the target content) from the complex structures of webpages. Furthermore, the use of multiple agents, as opposed to a single agent, improves the accuracy and effectiveness of the generated script, especially if a critique agent provides accuracy determinations and feedback to other agents.

This also improves the technical field of natural language processing and generating automated output based on human-generated natural language. Specifically, storing data describing target content of webpages as opposed to data describing the entire content of webpages provides targeted and relevant data for a chatbot to reference, thus improving the response times (less data to access and process) and the accuracy of the chatbot's responses. The stored data may also be used to generate improved chatbots by, for example, using the data describing target content to fine tune or prompt tune a chatbot. Furthermore, storing data describing the target content of webpages as opposed to data describing the entire content of webpages is a more efficient use of database storage, resulting in reduced time to access stored data.

### BRIEF DESCRIPTION OF THE DRAWINGS

FIG. 1A illustrates an example system environment for an online system, in accordance with one or more embodiments.

FIG. 1B illustrates an example system environment for an online system, in accordance with one or more embodiments.

FIG. 2 illustrates an example system architecture for an online system, in accordance with one or more embodiments.

FIG. 3 is a flowchart for a method of identifying, extracting, storing, and accessing target content of a webpage, in accordance with some embodiments.

FIG. 4 is a block diagram of a webpage content extractor system, in accordance with one or more embodiments.

FIG. 5 is a block diagram of the multi-agent code generator of FIG. 4, in accordance with one or more embodiments.

### DETAILED DESCRIPTION

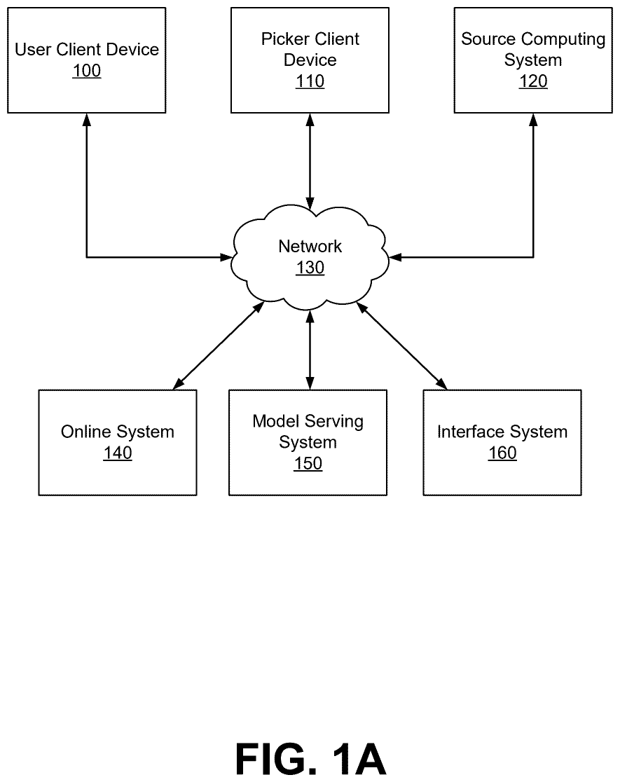

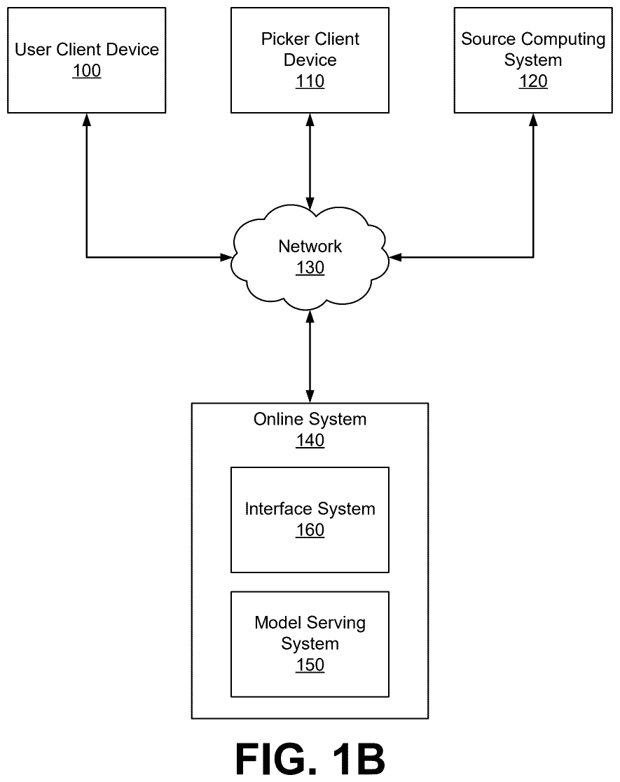

FIG. 1A illustrates an example system environment for an online system 140, in accordance with one or more embodiments. The system environment illustrated in FIG. 1A includes a user client device 100, a picker client device 110, a source computing system 120, a network 130, and an online system 140. Alternative embodiments may include more, fewer, or different components from those illustrated in FIG. 1A, and the functionality of each component may be divided between the components differently from the description below. Additionally, each component may perform their respective functionalities in response to a request from a human, or automatically without human intervention.

Although one user client device 100, picker client device 110, and source computing system 120 are illustrated in FIG. 1A, any number of users, pickers, and sources may interact with the online system 140. As such, there may be more than one user client device 100, picker client device 110, or source computing system 120.

The user client device 100 is a client device through which a user may interact with the picker client device 110, the source computing system 120, or the online system 140. The user client device 100 can be a personal or mobile computing device, such as a smartphone, a tablet, a laptop computer, or desktop computer. In some embodiments, the user client device 100 executes a client application that uses an application programming interface (API) to communicate with the online system 140.

A user uses the user client device 100 to place an order with the online system 140. An order specifies a set of items to be delivered to the user. An “item,” as used herein, means a good or product that can be provided to the user through the online system 140. The order may include item identifiers (e.g., a stock keeping unit (SKU) or a price look-up (PLU) code) for items to be delivered to the user and may include quantities of the items to be delivered. Additionally, an order may further include a delivery location to which the ordered items are to be delivered and a timeframe during which the items should be delivered. In some embodiments, the order also specifies one or more sources from which the ordered items should be collected.

The user client device 100 presents an ordering interface to the user. The ordering interface is a user interface that the user can use to place an order with the online system 140. The ordering interface may be part of a client application operating on the user client device 100. The ordering interface allows the user to search for items that are available through the online system 140 and the user can select which items to add to an “ordering list.” A “ordering list,” as used herein, is a tentative set of items that the user has selected for an order but that has not yet been finalized for an order. The ordering list may alternatively be referred to as a “cart” or “shopping cart.” The ordering interface allows a user to update the ordering list, e.g., by changing the quantity of items, adding or removing items, or adding instructions for items that specify how the item should be collected.

The user client device 100 may receive additional content from the online system 140 to present to a user. For example, the user client device 100 may receive coupons, recipes, or item suggestions. The user client device 100 may present the received additional content to the user as the user uses the user client device 100 to place an order (e.g., as part of the ordering interface).

Additionally, the user client device 100 includes a communication interface that allows the user to communicate with a picker that is servicing the user's order. This communication interface allows the user to input a text-based message to transmit to the picker client device 110 via the network 130. The picker client device 110 receives the message from the user client device 100 and presents the message to the picker. The picker client device 110 also includes a communication interface that allows the picker to communicate with the user. The picker client device 110 transmits a message provided by the picker to the user client device 100 via the network 130. In some embodiments, messages sent between the user client device 100 and the picker client device 110 are transmitted through the online system 140. In addition to text messages, the communication interfaces of the user client device 100 and the picker client device 110 may allow the user and the picker to communicate through audio or video communications, such as a phone call, a voice-over-IP call, or a video call.

The picker client device 110 is a client device through which a picker may interact with the user client device 100, the source computing system 120, or the online system 140. The picker client device 110 can be a personal or mobile computing device, such as a smartphone, a tablet, a laptop computer, or a desktop computer. In some embodiments, the picker client device 110 executes a client application that uses an application programming interface (API) to communicate with the online system 140.

The picker client device 110 receives orders from the online system 140 for the picker to service. A picker services an order by collecting the items listed in the order from a source. The picker client device 110 presents the items that are included in the user's order to the picker in a collection interface. The collection interface is a user interface that provides information to the picker on which items to collect for a user's order and the quantities of the items. In some embodiments, the collection interface provides multiple orders from multiple users for the picker to service at the same time from the same source location. The collection interface further presents instructions that the user may have included related to the collection of items in the order. Additionally, the collection interface may present a location of each item at the source, and may even specify a sequence in which the picker should collect the items for improved efficiency in collecting items. In some embodiments, the picker client device 110 transmits to the online system 140 or the user client device 100 which items the picker has collected in real time as the picker collects the items.

The picker can use the picker client device 110 to keep track of the items that the picker has collected to ensure that the picker collects all the items for an order. The picker client device 110 may include a barcode scanner that can decode an item identifier encoded in a machine-readable label (e.g., a barcode or a QR code) coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and identifies the item identifier for the item based on the images. The picker client device 110 may determine the item identifier directly or by transmitting the images to the online system 140. Furthermore, the picker client device 110 determines weights for items that are priced by weight. The picker client device 110 may prompt the picker to manually input the weight of an item or may communicate with a weighing system in the source location to receive the weight of an item.

When the picker has collected the items for an order, the picker client device 110 instructs a picker on where to deliver the items for a user's order. For example, the picker client device 110 displays a delivery location from the order to the picker. The picker client device 110 also provides navigation instructions for the picker to travel from the source location to the delivery location. When a picker is servicing more than one order, the picker client device 110 identifies which items should be delivered to which delivery location. The picker client device 110 may provide navigation instructions from the source location to each of the delivery locations. The picker client device 110 may receive one or more delivery locations from the online system 140 and may provide the delivery locations to the picker so that the picker can deliver the corresponding one or more orders to those locations. The picker client device 110 may also provide navigation instructions for the picker from the source location from which the picker collected the items to the one or more delivery locations.

In some embodiments, the picker client device 110 tracks the location of the picker as the picker delivers orders to delivery locations. The picker client device 110 collects location data and transmits the location data to the online system 140. The online system 140 may transmit the location data to the user client device 100 for display to the user, so that the user can keep track of when their order will be delivered. Additionally, the online system 140 may generate updated navigation instructions for the picker based on the picker's location. For example, if the picker takes a wrong turn while traveling to a delivery location, the online system 140 determines the picker's updated location based on location data from the picker client device 110 and generates updated navigation instructions for the picker based on the updated location.

In some embodiments, the picker is a single person who collects items for an order from a source location and delivers the order to the delivery location for the order. Alternatively, more than one person may serve the role of a picker for an order. For example, multiple people may collect the items at the source location for a single order. Similarly, the person who delivers an order to its delivery location may be different from the person or people who collected the items from the source location. In these embodiments, each person may have a picker client device 110 that they can use to interact with the online system 140.

Additionally, while the description herein may primarily refer to pickers as humans, in some embodiments, some or all of the steps taken by the picker may be automated. For example, a semi- or fully-autonomous robot may collect items in a source location for an order and an autonomous vehicle may deliver an order to a user from a source location.

In one or more embodiments, the online system 140 communicates with a smart shopping cart being used by a user to collect items in a source location. For example, the smart shopping cart may display content received from the online system and may receive data describing items that are collected by the user and stored in a storage area of the shopping cart. In some embodiments, the smart shopping cart is a picker client device 110 being operated by a picker collecting items within a source location. Similarly, the smart shopping cart may be operated by a user within the source location collecting items for themselves. Example embodiments of smart shopping carts are described in U.S. patent application Ser. No. 18/630,672, entitled “Automated Identification of Items Placed in a Cart and Recommendations based on Same,” filed Apr. 9, 2024, which is hereby incorporated by reference in its entirety.

The source computing system 120 is a computing system operated by a source that interacts with the online system 140. As used herein, a “source” is an entity that operates a “source location,” which is a store, warehouse, or any other source from which a picker can collect items. The source computing system 120 stores and provides item data to the online system 140 and may regularly update the online system 140 with updated item data. For example, the source computing system 120 provides item data indicating which items are available at a particular source location and the quantities of those items. Additionally, the source computing system 120 may transmit updated item data to the online system 140 when an item is no longer available at the source location. Additionally, the source computing system 120 may provide the online system 140 with updated item prices, sales, or availabilities. Additionally, the source computing system 120 may receive payment information from the online system 140 for orders serviced by the online system 140. Alternatively, the source computing system 120 may provide payment to the online system 140 for some portion of the overall cost of a user's order (e.g., as a commission).

The user client device 100, the picker client device 110, the source computing system 120, and the online system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of the standard layers used to describe a physical or virtual network, such as the physical layer, the data link layer, the network layer, the transport layer, the session layer, the presentation layer, and the application layer. The network 130 may include physical media for communicating data from one computing device to another computing device, such as multiprotocol label switching (MPLS) lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online system 140 is an online system by which users can order items to be provided to them by a picker from a source. The online system 140 receives orders from a user client device 100 through the network 130. The online system 140 selects a picker to service the user's order and transmits the order to a picker client device 110 associated with the picker. If the picker accepts the order, the picker collects the ordered items from a source location and delivers the ordered items to the user. The online system 140 may charge a user for the order and provide portions of the payment from the user to the picker and the source.

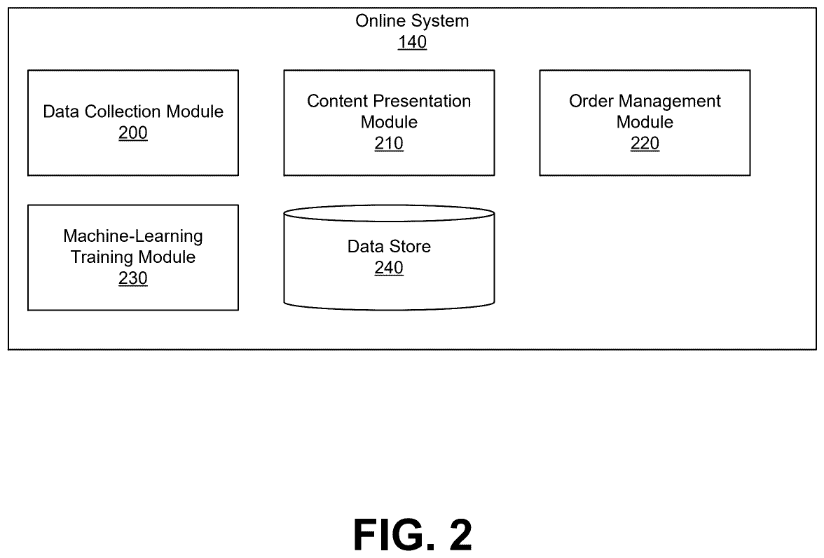

As an example, the online system 140 may allow a user to order groceries from a grocery store source. The user's order may specify which groceries they want to be delivered from the grocery store and the quantities of each of the groceries. The user's client device 100 transmits the user's order to the online system 140 and the online system 140 selects a picker to travel to the grocery store source location to collect the groceries ordered by the user. The online system transmits an offer to the picker for the picker to service the order in exchange for consideration and, if the picker accepts the offer, the picker collects the groceries from the grocery store. Once the picker has collected the groceries ordered by the user, the picker delivers the groceries to a location transmitted to the picker client device 110 by the online system 140. The online system 140 is described in further detail below with regards to FIG. 2.

The model serving system 150 receives requests from the online system 140 to perform tasks using machine-learned models. The tasks include, but are not limited to, natural language processing (NLP) tasks, audio processing tasks, image processing tasks, video processing tasks, and the like. In some embodiments, the machine-learned models deployed by the model serving system 150 are models configured to perform one or more NLP tasks. The NLP tasks include, but are not limited to, text generation, query processing, machine translation, chatbots, and the like. In some embodiments, the language model is configured as a transformer neural network architecture. Specifically, the transformer model is coupled to receive sequential data tokenized into a sequence of input tokens and generates a sequence of output tokens depending on the task to be performed.

The model serving system 150 receives a request including input data (e.g., text data, audio data, image data, or video data) and encodes the input data into a set of input tokens. The model serving system 150 applies the machine-learned model to generate a set of output tokens. Each token in the set of input tokens or the set of output tokens may correspond to a text unit. For example, a token may correspond to a word, a punctuation symbol, a space, a phrase, a paragraph, and the like. For an example query processing task, the language model may receive a sequence of input tokens that represent a query and generate a sequence of output tokens that represent a response to the query. For a translation task, the transformer model may receive a sequence of input tokens that represent a paragraph in German and generate a sequence of output tokens that represents a translation of the paragraph or sentence in English. For a text generation task, the transformer model may receive a prompt and continue the conversation or expand on the given prompt in human-like text.

When the machine-learning model is a language model, the sequence of input tokens or output tokens are arranged as a tensor with one or more dimensions, for example, one dimension, two dimensions, or three dimensions. For example, one dimension of the tensor may represent the number of tokens (e.g., length of a sentence), one dimension of the tensor may represent a sample number in a batch of input data that is processed together, and one dimension of the tensor may represent a space in an embedding space. However, it is appreciated that in other embodiments, the input data or the output data may be configured as any number of appropriate dimensions depending on whether the data is in the form of image data, video data, audio data, and the like. For example, for three-dimensional image data, the input data may be a series of pixel values arranged along a first dimension and a second dimension, and further arranged along a third dimension corresponding to RGB channels of the pixels.

In some embodiments, the language models are large language models (LLMs) that are trained on a large corpus of training data to generate outputs for the NLP tasks. An LLM may be trained on massive amounts of text data, often involving billions of words or text units. The large amount of training data from various data sources allows the LLM to generate outputs for many tasks. An LLM may have a significant number of parameters in a deep neural network (e.g., transformer architecture), for example, at least 1 billion, at least 15 billion, at least 135 billion, at least 175 billion, at least 500 billion, at least 1 trillion, at least 1.5 trillion parameters.

Since an LLM has significant parameter size and the amount of computational power for inference or training the LLM is high, the LLM may be deployed on an infrastructure configured with, for example, supercomputers that provide enhanced computing capability (e.g., graphic processor units) for training or deploying deep neural network models. In one instance, the LLM may be trained and deployed or hosted on a cloud infrastructure service. The LLM may be pre-trained by the online system 140 or one or more entities different from the online system 140. An LLM may be trained on a large amount of data from various data sources. For example, the data sources include websites, articles, posts on the web, and the like. From this massive amount of data coupled with the computing power of LLM's, the LLM is able to perform various tasks and synthesize and formulate output responses based on information extracted from the training data.

In some embodiments, when the machine-learned model including the LLM is a transformer-based architecture, the transformer has a generative pre-training (GPT) architecture including a set of decoders that each perform one or more operations to input data to the respective decoder. A decoder may include an attention operation that generates keys, queries, and values from the input data to the decoder to generate an attention output. In another embodiment, the transformer architecture may have an encoder-decoder architecture and includes a set of encoders coupled to a set of decoders. An encoder or decoder may include one or more attention operations.

While a LLM with a transformer-based architecture is described as a primary embodiment, it is appreciated that in other embodiments, the language model can be configured as any other appropriate architecture including, but not limited to, long short-term memory (LSTM) networks, Markov networks, BART, generative-adversarial networks (GAN), diffusion models (e.g., Diffusion-LM), and the like.

In some embodiments, the task for the model serving system 150 is based on knowledge of the online system 140 that is fed to the machine-learned model of the model serving system 150, rather than relying on general knowledge encoded in the model weights of the model. Thus, one objective may be to perform various types of queries on the external data in order to perform any task that the machine-learned model of the model serving system 150 could perform. For example, the task may be to perform question-answering, text summarization, text generation, and the like based on information contained in an external dataset.

Thus, In some embodiments, the online system 140 is connected to an interface system 160. The interface system 160 receives external data from the online system 140 and builds a structured index over the external data using, for example, another machine-learned language model or heuristics. The interface system 160 receives one or more queries from the online system 140 on the external data. The interface system 160 constructs one or more prompts for input to the model serving system 150. A prompt may include the query of the user and context obtained from the structured index of the external data. In one instance, the context in the prompt includes portions of the structured indices as contextual information for the query. The interface system 160 obtains one or more responses from the model serving system 160 and synthesizes a response to the query on the external data. While the online system 140 can generate a prompt using the external data as context, often times, the amount of information in the external data exceeds prompt size limitations configured by the machine-learned language model. The interface system 160 can resolve prompt size limitations by generating a structured index of the data and offers data connectors to external data sources.

FIG. 1B illustrates an example system environment for an online system 140, in accordance with one or more embodiments. The system environment illustrated in FIG. 1B includes a user client device 100, a picker client device 110, a source computing system 120, a network 130, and an online system 140. Alternative embodiments may include more, fewer, or different components from those illustrated in FIG. 1B, and the functionality of each component may be divided between the components differently from the description below. Additionally, each component may perform their respective functionalities in response to a request from a human, or automatically without human intervention.

The example system environment in FIG. 1A illustrates an environment where the model serving system 150 or the interface system 160 is managed by a separate entity from the online system 140. In some embodiments, as illustrated in the example system environment in FIG. 1B, the model serving system 150 or the interface system 160 is managed and deployed by the entity managing the online system 140.

FIG. 2 illustrates an example system architecture for an online system 140, in accordance with some embodiments. The system architecture illustrated in FIG. 2 includes a data collection module 200, a content presentation module 210, an order management module 220, a machine-learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 240. In preferred embodiments, the data collection module 200 only collects data describing a user if the user has previously explicitly consented to the online system 140 collecting data describing the user. Additionally, the data collection module 200 may encrypt all data, including sensitive or personal data, describing users.

For example, the data collection module 200 collects user data, which is information or data that describe characteristics of a user. User data may include a user's name, address, shopping preferences, favorite items, or stored payment instruments. The user data also may include default settings established by the user, such as a default source/source location, payment instrument, delivery location, or delivery timeframe. The data collection module 200 may collect the user data from sensors on the user client device 100 or based on the user's interactions with the online system 140.

The data collection module 200 also collects item data, which is information or data that identifies and describes items that are available at a source location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in source locations. For example, for each item-source combination (a particular item at a particular warehouse), the item data may include a time that the item was last found, a time that the item was last not found (a picker looked for the item but could not find it), the rate at which the item is found, or the popularity of the item. The data collection module 200 may collect item data from a source computing system 120, a picker client device 110, or the user client device 100.

An item category is a set of items that are a similar type of item. Items in an item category may be considered to be equivalent to each other or may be replacements for each other in an order. For example, different brands of sourdough bread may be different items, but these items may be in a “sourdough bread” item category. The item categories may be human-generated and human-populated with items. The item categories also may be generated automatically by the online system 140 (e.g., using a clustering algorithm).

The data collection module 200 also collects picker data, which is information or data that describes characteristics of pickers. For example, the picker data for a picker may include the picker's name, the picker's location, how often the picker has serviced orders for the online system 140, a user rating for the picker, which sources the picker has collected items at, or the picker's previous shopping history. Additionally, the picker data may include preferences expressed by the picker, such as their preferred sources to collect items at, how far they are willing to travel to deliver items to a user, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online system 140.

Additionally, the data collection module 200 collects order data, which is information or data that describes characteristics of an order. For example, order data may include item data for items that are included in the order, a delivery location for the order, a user associated with the order, a source location from which the user wants the ordered items collected, or a timeframe within which the user wants the order delivered. Order data may further include information describing how the order was serviced, such as which picker serviced the order, when the order was delivered, or a rating that the user gave the delivery of the order. In some embodiments, the order data includes user data for users associated with the order, such as user data for a user who placed the order or picker data for a picker who serviced the order.

While user data, picker data, source data, item data, and order data are described separately, data collected by the data collection module 200 may fall into more than one of these categories. For example, data describing a picker's performance for an order may be order data and picker data.

The content presentation module 210 selects content for presentation to a user. For example, the content presentation module 210 selects which items to present to a user while the user is placing an order. The content presentation module 210 generates and transmits an ordering interface for the user to order items. The content presentation module 210 populates the ordering interface with items that the user may select for adding to their order. In some embodiments, the content presentation module 210 presents a catalog of all items that are available to the user, which the user can browse to select items to order. The content presentation module 210 also may identify items that the user is most likely to order and present those items to the user. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a user. An item selection model is a machine-learning model that is trained to score items for a user based on item data for the items and user data for the user. For example, the item selection model may be trained to determine a likelihood that the user will order the item. In some embodiments, the item selection model uses item embeddings describing items and user embeddings describing users to score items. These item embeddings and user embeddings may be generated by separate machine-learning models and may be stored in the data store 240.

In some embodiments, the content presentation module 210 scores items based on a search query received from the user client device 100. A search query is free text for a word or set of words that indicate items of interest to the user. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a user (e.g., by comparing a search query embedding to an item embedding).

In some embodiments, the content presentation module 210 scores items based on a predicted availability of an item. The content presentation module 210 may use an availability model to predict the availability of an item. An availability model is a machine-learning model that is trained to predict the availability of an item at a particular source location. For example, the availability model may be trained to predict a likelihood that an item is available at a source location or may predict an estimated number of items that are available at a source location. The content presentation module 210 may apply a weight to the score for an item based on the predicted availability of the item. Alternatively, the content presentation module 210 may filter out items from presentation to a user based on whether the predicted availability of the item exceeds a threshold.

The order management module 220 manages orders for items from users. The order management module 220 receives orders from a user client device 100 and offers the orders to pickers for service based on picker data. For example, the order management module 220 offers an order to a picker based on the picker's location and the location of the source from which the ordered items are to be collected. The order management module 220 may also offer an order to a picker based on how many items are in the order, a vehicle operated by the picker, the delivery location, the picker's preferences on how far to travel to deliver an order, the picker's ratings by users, or how often a picker agrees to service an order.

In some embodiments, the order management module 220 determines when to offer an order to a picker based on a delivery timeframe requested by the user with the order. The order management module 220 computes an estimated amount of time that it would take for a picker to collect the items for an order and deliver the ordered items to the delivery location for the order. The order management module 220 offers the order to a picker at a time such that, if the picker immediately accepts and services the order, the picker is likely to deliver the order at a time within the requested timeframe. Thus, when the order management module 220 receives an order, the order management module 220 may delay offering the order to a picker if the requested timeframe is far enough in the future (i.e., the picker may be offered the order at a later time and is still predicted to meet the requested timeframe).

When the order management module 220 offers an order to a picker, the order management module 220 transmits the order to the picker client device 110 associated with the picker. The order management module 220 may also transmit navigation instructions from the picker's current location to the source location associated with the order. If the order includes items to collect from multiple source locations, the order management module 220 identifies the source locations to the picker and may also specify a sequence in which the picker should visit the source locations.

The order management module 220 may track the location of the picker through the picker client device 110 to determine when the picker arrives at the source location. When the picker arrives at the source location, the order management module 220 transmits the order to the picker client device 110 for display to the picker. As the picker uses the picker client device 110 to collect items at the source location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the user client device 100 that describe which items have been collected for the user's order.

In some embodiments, the order management module 220 tracks the location of the picker within the source location. The order management module 220 uses sensor data from the picker client device 110 or from sensors in the source location to determine the location of the picker in the source location. The order management module 220 may transmit, to the picker client device 110, instructions to display a map of the source location indicating where in the source location the picker is located. Additionally, the order management module 220 may instruct the picker client device 110 to display the locations of items for the picker to collect, and may further display navigation instructions for how the picker can travel from their current location to the location of the next item to collect for an order.

The order management module 220 determines when the picker has collected the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the source location to the delivery location, or to a subsequent source location for further item collection. The order management module 220 tracks the location of the picker as the picker travels to the delivery location for an order, and updates the user with the location of the picker so that the user can track the progress of the order. In some embodiments, the order management module 220 computes an estimated time of arrival of the picker at the delivery location and provides the estimated time of arrival to the user.

In some embodiments, the order management module 220 facilitates communication between the user client device 100 and the picker client device 110. As noted above, a user may use a user client device 100 to send a message to the picker client device 110. The order management module 220 receives the message from the user client device 100 and transmits the message to the picker client device 110 for presentation to the picker. The picker may use the picker client device 110 to send a message to the user client device 100 in a similar manner.

The order management module 220 coordinates payment by the user for the order. The order management module 220 uses payment information provided by the user (e.g., a credit card number or a bank account) to receive payment for the order. In some embodiments, the order management module 220 stores the payment information for use in subsequent orders by the user. The order management module 220 computes the total cost for the order and charges the user that cost. The order management module 220 may provide a portion of the total cost to the picker for servicing the order, and another portion of the total cost to the source.

The machine-learning training module 230 trains machine-learning models used by the online system 140. For example, the machine learning module 230 may train the item selection model, the availability model, or any of the machine-learned models deployed by the model serving system 150. The online system 140 may use machine-learning models to perform functionalities described herein. Example machine-learning models include regression models, support vector machines, naïve Bayes, decision trees, k nearest neighbors, random forest, boosting algorithms, k-means, and hierarchical clustering. The machine-learning models may also include neural networks, such as perceptrons, multilayer perceptrons, convolutional neural networks, recurrent neural networks, sequence-to-sequence models, generative adversarial networks, transformers, large-language models, or multi-modal large language models. A machine-learning model may include components relating to these different general categories of model, which may be sequenced, layered, or otherwise combined in various configurations. While the term “machine-learning model” may be broadly used herein to refer to any kind of machine-learning model, the term is generally limited to those types of models that are suitable for performing the described functionality. For example, certain types of machine-learning models can perform a particular functionality based on the intended inputs to, and outputs from, the model, the capabilities of the system on which the machine-learning model will operate, or the type and availability of training data for the model.

Each machine-learning model includes a set of parameters. The set of parameters for a machine-learning model are parameters that the machine-learning model uses to process an input to generate an output. For example, a set of parameters for a linear regression model may include weights that are applied to each input variable in the linear combination that comprises the linear regression model. Similarly, the set of parameters for a neural network may include weights and biases that are applied at each neuron in the neural network. The machine-learning training module 230 generates the set of parameters (e.g., the particular values of the parameters) for a machine-learning model by “training” the machine-learning model. Once trained, the machine-learning model uses the set of parameters to transform inputs into outputs.

The machine-learning training module 230 trains a machine-learning model based on a set of training examples. Each training example includes input data to which the machine-learning model is applied to generate an output. For example, each training example may include user data, picker data, item data, or order data. In some cases, the training examples also include a label which represents an expected output of the machine-learning model. In these cases, the machine-learning model is trained by comparing its output from the input data of a training example to the label for the training example. In general, during training with labeled data, the set of parameters of the model may be set or adjusted to reduce a difference between the output for the training example (given the current parameters of the model) and the label for the training example.

The machine-learning training module 230 may apply an iterative process to train a machine-learning model whereby the machine-learning training module 230 updates parameter values of the machine-learning model based on each of the set of training examples. The training examples may be processed together, individually, or in batches. To train a machine-learning model based on a training example, the machine-learning training module 230 applies the machine-learning model to the input data in the training example to generate an output based on a current set of parameter values. The machine-learning training module 230 scores the output from the machine-learning model using a loss function. A loss function is a function that generates a score for the output of the machine-learning model such that the score is higher when the machine-learning model performs poorly and lower when the machine-learning model performs well. In cases where the training example includes a label, the loss function is also based on the label for the training example. Some example loss functions include the mean square error function, the mean absolute error, hinge loss function, and the cross entropy loss function. The machine-learning training module 230 updates the set of parameters for the machine-learning model based on the score generated by the loss function. For example, the machine-learning training module 230 may apply gradient descent to update the set of parameters.

In some embodiments, the machine-learning training module 230 may retrain the machine-learning model based on the actual performance of the model after the online system 140 has deployed the model to provide service to users. For example, if the machine-learning model is used to predict a likelihood of an outcome of an event, the online system 140 may log the prediction and an observation of the actual outcome of the event. Alternatively, if the machine-learning model is used to classify an object, the online system 140 may log the classification as well as a label indicating a correct classification of the object (e.g., following a human labeler or other inferred indication of the correct classification). After sufficient additional training data has been acquired, the machine-learning training module 230 re-trains the machine-learning model using the additional training data, using any of the methods described above. This deployment and re-training process may be repeated over the lifetime use for the machine-learning model. This way, the machine-learning model continues to improve its output and adapts to changes in the system environment, thereby improving the functionality of the online system 140 as a whole in its performance of the tasks described herein.

The data store 240 stores data used by the online system 140. For example, the data store 240 stores user data, item data, order data, and picker data for use by the online system 140. The data store 240 also stores trained machine-learning models trained by the machine-learning training module 230. For example, the data store 240 may store the set of parameters for a trained machine-learning model on one or more non-transitory, computer-readable media. The data store 240 uses computer-readable media to store data, and may use databases to organize the stored data.

With respect to the machine-learned models hosted by the model serving system 150, the machine-learned models may already be trained by a separate entity from the entity responsible for the online system 140. In another embodiment, when the model serving system 150 is included in the online system 140, the machine-learning training module 230 may further train parameters of the machine-learned model based on data specific to the online system 140 stored in the data store 240. As an example, the machine-learning training module 230 may obtain a pre-trained transformer language model and further fine tune the parameters of the transformer model using training data stored in the data store 240. The machine-learning training module 230 may provide the model to the model serving system 150 for deployment.

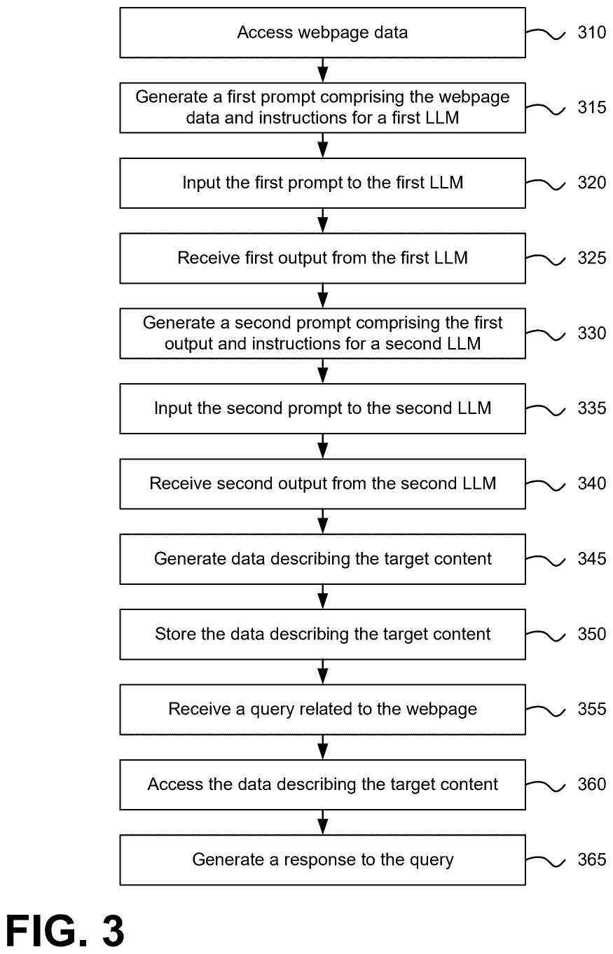

FIG. 3 is a flowchart for a method of identifying, extracting, storing, and accessing target content of a webpage, in accordance with some embodiments. Alternative embodiments may include more, fewer, or different steps from those illustrated in FIG. 3, and the steps may be performed in a different order from that illustrated in FIG. 3. These steps may be performed by an online system (e.g., online system 140). Additionally, each of these steps may be performed automatically by the online system without human intervention. Additionally, although the description below relates to extracting target content from a webpage, the method may be applicable or modified for extracting target content from other sources, such as documents, text files, image files, or video files. Furthermore, several steps of the method may be performed by one or more agents. As used herein, an agent may refer to a system that interfaces with an LLM. For example, an agent generates a prompt for an LLM, transmits the prompt to the LLM, and receives the output from the LLM.

At step 310, the online system accesses webpage data describing a webpage, wherein the webpage comprises target content. For example, the webpage data includes a screenshot of the webpage, HTML (Hypertext Markup Language) code of the webpage, or any combination thereof. Analyzing both the screenshot and the HTML code results in an improved determination of the structure of the webpage and an improved determination of target content of the webpage by an LLM (e.g., as further described with respect to steps 315-325).

The target content of a webpage may refer to content of the webpage that may be useful for a chatbot (e.g., useful to access in order to answer user queries, useful for prompt tuning the chatbot, useful for fine tuning the chatbot, or any combination thereof). For example, target content may refer to the main content of a webpage and may exclude content on a header or on a sidebar that includes information unrelated to the main content of the webpage. Other examples of target content include information (e.g., specifications, FAQs, help documentation, user guides) related to an object, process, or system (e.g., a product). Other possible examples of non-target content include navigational elements, header information, footer information, and advertisements (more generally, non-target content may refer to content of a webpage that is not useful for a chatbot). Target content may be described or defined by a user (e.g., a developer). For example, a user provides input (via a client device) describing what type of content should be identified or extracted from one or more webpages. This input may be included in a prompt for an LLM (e.g., the first prompt for the first LLM further described with respect to steps 315 and 320).

At step 315, the online system generates (e.g., by a content analysis agent), a first prompt comprising the webpage data and instructions for a first LLM to: (a) analyze the webpage data describing the webpage to determine a structure of the webpage and to identify target content of the webpage and (b) generate first output describing the determined structure of the webpage and the identified target content. The prompt may also include good and bad examples (e.g., provided by a developer user) of webpage structure determination and target content identification. The online system may add additional examples over time to improve the prompt.

The structure of the webpage may refer to the format or organization of content on the webpage (e.g., the location of text, images, and videos) or to the organization of the user interface elements (e.g., the location and content of buttons, headers, and sidebars). The structure may be determined by the prompt instructions including instructions to analyze the HTML code of the webpage (e.g., in conjunction with a screenshot of the webpage). For example, the prompt includes instructions to identify tags of the HTML code in order to identify sections of the webpage. In some embodiments, the prompt includes instructions to identify: the HTML semantic structure (e.g., header, main, article, section, aside tags), content hierarchy (h1, h2, h3 headings), navigation elements vs. content elements, primary content containers vs. secondary content areas, layout patterns (multi-column, single-column, sidebar arrangements), or any combination thereof. To perform one or more of the above, in some embodiments, the prompt may include instructions to: analyze HTML tag semantics and class names, identify CSS selectors that indicate content areas, perform pattern recognition based on common webpage layouts, cross-reference the HTML structure with the screenshot data, refer to trained examples of properly identified webpage structures (e.g., which are in the prompt), or any combination thereof.

The identified target content of the webpage may be a description of the target content (meaning the description may describe what the target content is rather than being the content itself), such as a summary or high-level description of the target content; a description of where the target content is in the webpage; a description of how to locate the target content in the webpage; the content itself; or any combination thereof (thus, the first prompt can include instructions to generate any combination of these). To identify the target content, the prompt instructions may include instructions to identify target content according to the determined structure of the webpage (e.g., according to the HTML structure of the webpage). For example, the structure of the webpage indicates the main content of the webpage (e.g., one or more HTML tags indicate the main content of the webpage). Additionally, or alternatively, the prompt instructions may include more general instructions to determine the target content, such as instructions to identify content of the webpage that may be useful for a chatbot or to identify the main content to the webpage. The instructions may further include instructions to ignore content irrelevant to the main content of the webpage. In some embodiments, the prompt includes instructions to: analyze HTML semantic tags (e.g., main, article, section) that (e.g., typically) include primary or target content, identify content areas with high text density and low navigational elements, recognize one or more patterns where the main content area is visually prominent in one or more screenshots, exclude areas marked with sidebar, navigation, or advertisement class names, focus on content within the primary content container (e.g., as determined by the structural analysis), use heuristics (such as content length, heading structure, and paragraph density) to distinguish main content from peripheral content, or any combination thereof.

At step 320, the online system inputs the first prompt to the first LLM.

At step 325, the online system receives, from the first LLM, the first output describing the identified target content (e.g., and the determined structure of the webpage).

At step 330, the online system generates (e.g., by a code generation agent) a second prompt comprising the first output and instructions for a second LLM to, based on the first output, generate a script that, when executed, extracts the identified target content of the webpage from the webpage. For example, the prompt includes instructions to generate a (e.g., Python) script designed to extract a specific portion of content from the webpage. The prompt may include instructions for the script to use one or more functions or libraries to fetch the webpage's HTML and to parse the HTML. Additionally, the prompt may include instructions for the script to be configured to extract the target content of the webpage (as opposed to all content) by specifying specific HTML tags or attributes (e.g., specified in the first input). Additionally, or alternatively, the script may be customized to handle the specific structure of the webpage (since the structure may be specified in the first input). More generally, the prompt may include instructions such that the resulting script is a script customized to extract the specific target content from the specific webpage. Note that the code generation agent may be a different agent or the same agent as the content analysis agent. Similarly, the first LLM may be a different LLM or the same LLM as the second LLM. Furthermore, the prompt may also include good and bad examples (e.g., provided by a developer user) of generated scripts. For example, the second LLM may be prompted with approved script code that was generated for other pages that were crawled from the same seed link as the webpage currently being analyzed. The online system may add additional examples over time to improve the prompt.

At step 335, the online system inputs the second prompt to the second LLM.

At step 340, the online system receives, from the second LLM, second output including an executable script (e.g., consistent with the instructions of the second prompt).

At step 345, the online system generates (e.g., by a non-LLM) data describing the target content of the webpage by executing the script (e.g., on at least a portion of the webpage data). The generated data may be structured data configured to be stored in a database, such as a document, a text file, a web page, or some other structured data.

At step 350, the online system stores the data describing the target content of the webpage in a database (e.g., data store 240).

At step 355, the online system (e.g., a chatbot) receives a query (e.g., a request or question) related to the webpage from a client device associated with a user. For example, the query relates to content of the webpage (e.g., requests information that is in the webpage). In another example, a response to the query can be generated using information from the webpage.

At step 360, the online system accesses the data describing the target content of the webpage from the database (e.g., in order to respond to the query). Step 360 may be performed by the online system responsive to receiving the query.

At step 365, the online system generates a response to the query based on the accessed data describing the target content of the webpage. The response may be transmitted to the client device (e.g., for display in a user interface).

The method describes a process for generating data that the online system (e.g., a chatbot) may use to respond to user questions and requests. For example, the data may be a resource for a help center for users or to answer questions from users (e.g., pickers) about their orders. In some embodiments, the user's identity, the user's device/platform on which they're making the request, the location of the user, or the user's status is passed to the online system (e.g., the chatbot) to better respond to the user's request (pending user approval). However, the data stored in the database (at step 350) may be used in other situations and in other ways (e.g., to prompt train an LLM chatbot, to fine tune an LLM chatbot, and to generate an LLM chatbot).

Among other advantages, since the stored data describing the target content of the webpage doesn't include other information of the webpage (e.g., information of the webpage irrelevant to the target content), the online system can generate a more relevant and appropriate response to the query. More generally, by storing only data that specifically describes the target content of webpages, while purposefully excluding unrelated or extraneous information, the online system is able to focus its responses on what is most relevant to user queries. This targeted storage approach reduces noise and reduces the likelihood of irrelevant details being included in generated responses. As a result, when a user submits a query, the system can efficiently retrieve and utilize the appropriate information, helping ensure that answers are, for example, precise, contextually appropriate, and aligned with the user's intent. This not only enhances the quality of the online system's interactions but also improves performance of the online system by reducing computational overhead, since only relevant data is processed and referenced during response generation.

In some embodiments, the method includes the use of an LLM to review and critique an output described above (e.g., the first and second outputs). To do this, an LLM may be prompted to provide an accuracy determination of an output which was generated in response to an input prompt. In general, the prompt may include instructions for the accuracy determination to specify whether the resulting output is accurate or effective. For example, an LLM is prompted to review the input prompt (and any data associated with the input prompt), to review the resulting output, and to evaluate whether the resulting output is accurate or effective (e.g., to score the output according to one or more metrics). An accuracy determination includes an approval or disapproval of the resulting output (e.g., whether the one or more scores meet a minimum threshold). In some embodiments, the accuracy determination includes a computed score by the LLM (e.g., indicating the likelihood the resulting output is accurate or effective). If the score is above a threshold value, that may indicate an approval of the resulting output and if the score is below a threshold value, that may indicate a disapproval.

In a first example of the method including the use of an LLM to review and critique an output, the method uses an LLM to critique the first output. More specifically, the method further includes generating (e.g., by a critique agent) a third prompt including the first output and instructions for a third LLM (e.g., the same as or different from any of the previous LLMs) to: generate an accuracy determination for the determined structure of the webpage and for the identified target content. The third prompt may also include the webpage data, such as a screenshot of the webpage or the HTML code of the webpage.

In general, the prompt may include instructions for the accuracy determination to specify whether the first output is an accurate or effective determination of the structure of the webpage or identification of the target content from the webpage. For example, the prompt includes the first output and instructions to compare the first output to the webpage data (e.g., “Is the target content of the first output the main content of the webpage?”). The third prompt may include examples of good and bad accuracy determinations (e.g., provided by a developer user) of a structure of a webpage or identifications of target content from a webpage. The online system may add additional examples over time to improve the prompt.

The third prompt may also include instructions to generate feedback for the first prompt or first LLM. The generation of feedback may be based on the accuracy determination for the determined structure of the webpage and for the identified target content. For example, the third prompt includes instructions to: responsive to the accuracy determination, disapprove the determined structure and the identified target content, and generate feedback for the first LLM. The feedback may, for example, specify errors in the first output or provide content for prompt tuning, such as additional instructions to be included in the first prompt.

The third prompt may be input into the third LLM and the online system may receive third output from the third LLM, where the third output includes the accuracy determination for the determined structure of the webpage and for the identified target content and the feedback for the first LLM.

In some embodiments, responsive to the accuracy determination disapproving the determined structure and the identified target content, the online system generates a fourth prompt including the feedback and instructions for the first LLM to revise the first output based on the feedback. More generally, the online system passes the feedback to an LLM to regenerate the second output. This cycle may be performed multiple times until the accuracy determination approves the first output. For example, the second prompt is only generated responsive to the accuracy determination from the third LLM approving the determined structure of the webpage and the identified target content from the first LLM.

In a second example of the method including the use of an LLM to review and critique an output, the method uses an LLM to critique the second output (this second example may be in addition to, or alternative, to the first example). More specifically, the method further includes generating (e.g., by a critique agent) a third prompt including instructions for a third LLM (e.g., the same as or different from any of the previous LLMs) to generate an accuracy determination indicating whether the executable script of the second output would, when executed, extract the target content of the webpage (e.g., analyze the python script for errors to determine whether it would execute properly); inputting the third prompt to the third LLM; and receiving, from the third LLM, third output including the accuracy determination for the executable script. The third prompt may include examples of good and bad accuracy determinations (e.g., provided by a developer user) for executable scripts. The online system may add additional examples over time to improve the prompt.

Generating the data describing the target content of the webpage (step 345) may be performed responsive to the accuracy determination for the executable script approving the executable script of the second output. For example, the third prompt includes instructions to: responsive to the accuracy determination disapproving the script, generate feedback for the second LLM. The feedback may, for example, specify errors in the second output or provide content for prompt tuning, such as additional instructions to be included in the second prompt. The online system may provide the feedback to the second LLM. For example, the online system generates a fourth prompt including the feedback and instructions for the second LLM to revise the second output based on the feedback. More generally, the online system passes the feedback to an LLM to regenerate the second output. This cycle may be performed multiple times until the accuracy determination approves the second output. After that, the online system may proceed to generate the data describing the target content of the webpage.

The method may include the online system performing one or more webpage data preprocessing steps prior to the online system accessing the webpage data (step 310). These preprocessing steps may increase the accuracy of the first output or reduce computation time to generate the first output (e.g., time to generate the first prompt or time for the first LLM to generate the first output). In a first example, the online system may apply certain filtering heuristics to the webpage data (e.g., a screenshot or HTML code), such as removing comments at the end of the page or copyright info. In a second example, in embodiments where the webpage data includes HTML code, the online system may preprocess the HTML code to remove metadata (e.g., that changes styling or content describing how the page should be rendered).

In some embodiments, accessing the webpage data includes: receiving a seed URL (Uniform Resource Locator) of the webpage; generating the screenshot of the webpage based on the seed URL; and retrieving the HTML code of the webpage based on the seed URL.

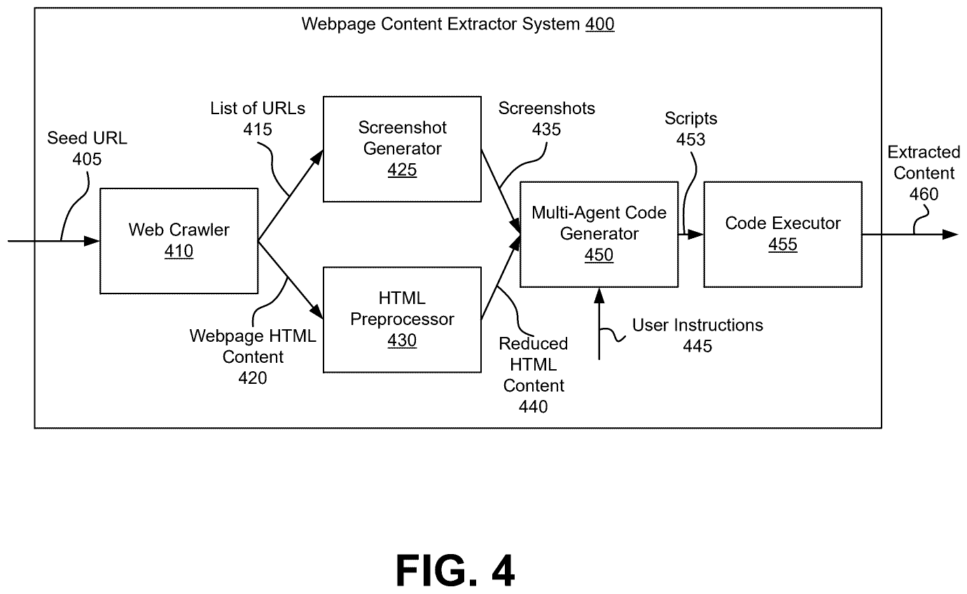

FIG. 4 is a block diagram of a webpage content extractor system 400 of the online system 140 (however the extractor system isn't required to be part of the online system 140), according to one or more embodiments. Alternative embodiments may include more, fewer, or different components from those illustrated in FIG. 4, and the functionality of each component may be divided between the components differently from the description below. Additionally, each component may perform their respective functionalities in response to a request from a human, or automatically without human intervention.

The webpage content extractor system 400 includes a web crawler 410, a screenshot generator 425, an HTML preprocessor 430, a multi-agent code generator 450, and a code executor 455. The web crawler 410 receives a seed URL 405 and generates a list of URLs 415 and webpage HTML content 420 based on the 405. The screenshot generator 425 receives the list of URLs 415 and generates screenshots 435 based on the list of URLs 415. The HTML preprocessor 430 receives the webpage HTML content 420 and generates reduced HTML content 440 based on the webpage HTML content 420. The multi-agent code generator 450 receives the screenshots 435, the HTML content 440, and user instructions 445 and generates executable code scripts 453 based on the received inputs. The code executor 455 receives the executable code scripts 453 and generates extracted content 460 based on the executable code scripts 453.

The web crawler 410 is an automated system (e.g., program) that can systematically browse the internet to index and collect information from websites. The web crawler 410 visits the webpage of the seed URL 405 and then follows any hyperlinks on that webpage to discover and index new webpages. More specifically, it generates the list of URLs 415 by adding URLs of webpages that are linked via one or more hyperlinks to the seed URL 405. The web crawler 410 also extracts the HTML content of the webpages of the list of URLs 415.

In general, the web crawler 410 is an automated component designed to systematically traverse websites by following hyperlinks, starting from the designated seed URL 405. The web crawler 410 sends HTTP requests to each discovered URL to retrieve the corresponding HTML content (which forms the webpage HTML content 420) and constructs the list of URLs 415 by recursively identifying and adding linked pages encountered during the crawl.

The screenshot generator 425 automatically captures screenshots of webpages from the list of URLs 415 to generate the screenshots 435. The HTML preprocessor 430 preprocesses HTML content of a webpage to make it easier to process by an LLM. For example, the HTML preprocessor 430 strips redundant content from the HTML to reduce noise and resize data to fit within an LLM's context window. In another example, the HTML preprocessor 430 removes metadata (e.g., that changes styling or content describing how the page should be rendered). The screenshot generator 425 or HTML preprocessor 430 may apply certain filtering heuristics to the webpage data (e.g., a screenshot or HTML code), such as removing comments at the end of the page or copyright info. A screenshot of a webpage (from the screenshots 435) and reduced HTML code for that website (from the reduced HTML content 440) may from the website data as described with respect to FIG. 3.

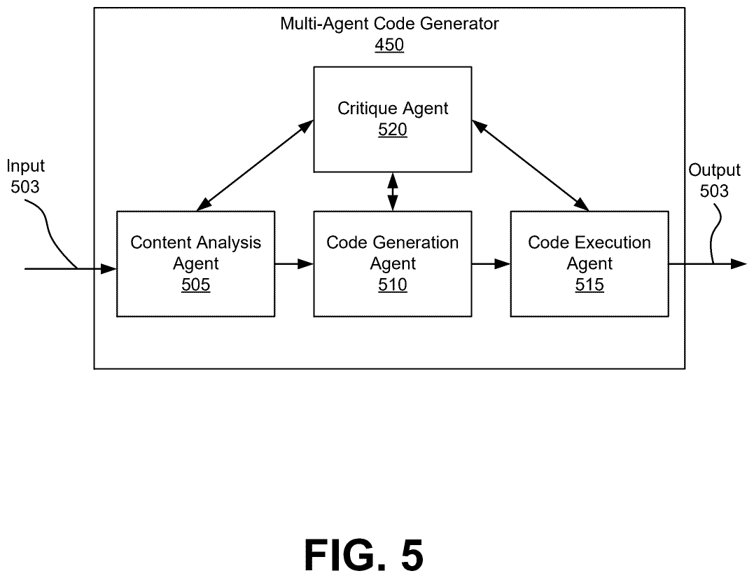

The multi-agent code generator 450 includes multiple agents that in conjunction result in executable scripts 453. The multi-agent code generator 450 is further described with respect to FIG. 5. The user instructions 445 are optionally provided to the multi-agent code generator 450 (more specifically, the content analysis agent 505 of FIG. 5). The user instructions 445 are instructions for identifying target content of a webpage.

The code executor 455 is a component that runs the (e.g., Python) scripts generated by the multi-agent code generator 450 to generate the extracted content 460 (e.g., data describing target content of one or more webpages). For example, the code executor 455 performs step 345 of FIG. 3.

FIG. 5 is a block diagram of the multi-agent code generator 450 of FIG. 4, according to one or more embodiments. The multi-agent code generator 450 includes a content analysis agent 505, a code generation agent 510, a code execution agent 515, and a critique agent 520. Alternative embodiments may include more, fewer, or different components from those illustrated in FIG. 5, and the functionality of each component may be divided between the components differently from the description below. Additionally, each component may perform their respective functionalities in response to a request from a human, or automatically without human intervention.

The content analysis agent 505 receives input 503, which is webpage data. For example, the input 503 is a webpage (e.g., from screenshots 435), HTML content of a webpage (e.g., from the reduced HTML content 440) and optionally user instructions 445. The content analysis agent 505 generates a prompt for an LLM based on the input 503 to determine the structure and target content of a webpage, inputs the prompt to an LLM, and receives output from the LLM. For example, the content analysis agent 505 performs steps 310-325 of FIG. 3.

The code generation agent 510 receives output from the content analysis agent 505, generates a prompt for an LLM based on the received output to generate a script, where the script, when executed, extracts target content of the webpage, inputs the prompt to an LLM, and receives output from the LLM. For example, the content analysis agent 505 performs steps 330-340 of FIG. 3.

The code execution agent 515 receives output from the code generation agent 510, generates a prompt for an LLM based on the received output, inputs the prompt to an LLM, and receives output from the LLM. The prompt generated by the code execution agent 515 may be instructions to execute a script from the code generation agent 510 and manage both the results and errors. For example, the code execution agent 515 may generate prompts for managing script execution, error handling, and result processing (or any combination thereof). The code execution agent 515 may act as an intelligent intermediary that can analyze execution results, handle errors through LLM-generated solutions, and format outputs appropriately.

The critique agent 520 evaluates the output from the other agents in the multi-agent code generator 450 and provides feedback to enhance their performance. For example, the critique agent 520 receives output from an agent (e.g., 505, 510, or 515), generates a prompt for an LLM based on the received agent output to evaluate the received agent output, inputs the prompt to an LLM, and receives output from the LLM. The output from the LLM includes an accuracy determination for the agent output. If the accuracy determination approves the agent output, that agent may subsequently transmit the agent output to the next agent or component in the pipeline (e.g., 510, 515, or 455). If the accuracy determination disapproves the agent output, the output from the LLM may also include feedback for the agent to improve a subsequent agent output (or the critique agent 520 may generate a subsequent prompt to provide feedback for the agent). An agent that receives feedback from the critique agent 520 may then interface with the respective LLM again to generate new output based on the feedback. For example, the feedback specifies errors in the agent output or provides content for prompt tuning, such as additional instructions to be included in a prompt. In some embodiments, agent output from an agent is not transmitted to the next agent or component in the pipeline until the critique agent 520 approves the agent output.

### Additional Considerations

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example, comparing an output of the machine-learning model to the label associated with the training example, and updating weights associated with the machine-learning model through a back-propagation process. The weights may be stored on one or more computer-readable media, and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a non-limiting example, the condition “A, B, or C” is satisfied when A and B are true (or present) and C is false (or not present). Similarly, as another non-limiting example, the condition “A, B, or C” is satisfied when A is true (or present) and B and C are false (or not present).

What is claimed is:

1. A method performed at a computer system comprising a processor and a computer-readable medium, the method comprising:
accessing webpage data describing a webpage, wherein the webpage comprises target content;
generating, by a content analysis agent, a first prompt comprising the webpage data and instructions for a first LLM (large language model) to:
analyze the webpage data describing the webpage to determine a structure of the webpage and to identify target content of the webpage; and
generate first output describing the determined structure of the webpage and the identified target content;
inputting the first prompt to the first LLM;
receiving, from the first LLM, the first output describing the determined structure of the webpage and the identified target content;
generating, by a code generation agent, a second prompt comprising the first output and instructions for a second LLM to, based on the first output, generate a script that, when executed, extracts the identified target content of the webpage;
inputting the second prompt to the second LLM;
receiving, from the second LLM, second output including an executable script;
generating data describing the target content of the webpage by executing the script on at least a portion of the webpage data;
storing the data describing the target content of the webpage in a database;
receiving a query related to the webpage from a client device associated with a user;
accessing the data describing the target content of the webpage from the database; and
generating a response to the query based on the accessed data describing the target content of the webpage.

2. The method of claim 1, further comprising:
generating a third prompt comprising the first output and instructions for a third LLM to:
generate an accuracy determination for the determined structure of the webpage and for the identified target content; and
responsive to the accuracy determination for the determined structure of the webpage and for the identified target content disapproving the determined structure and the identified target content, generate feedback for the first LLM;
inputting the third prompt to the third LLM; and
receiving, from the third LLM, fourth output including the accuracy determination for the determined structure of the webpage and for the identified target content and the feedback for the first LLM.

3. The method of claim 2, further comprising:
responsive to the accuracy determination for the determined structure of the webpage and for the identified target content disapproving the determined structure and the identified target content, generating a fourth prompt comprising the feedback and instructions for the first LLM to revise the first output based on the feedback.

4. The method of claim 1, wherein the second prompt is generated responsive to an accuracy determination from a third LLM approving the determined structure of the webpage and the identified target content from the first LLM.

5. The method of claim 1, further comprising:
generating, by a critique agent, a third prompt comprising instructions for a third LLM to generate an accuracy determination indicating whether the executable script of the second output would, when executed, extract the target content of the webpage;
inputting the third prompt to the third LLM; and
receiving, from the third LLM, third output including the accuracy determination for the executable script,
wherein generating the data describing the target content of the webpage is performed responsive to the accuracy determination for the executable script approving the executable script of the second output.

6. The method of claim 1, wherein the first prompt further comprises instructions from a second user describing how to identify the target content of the webpage.

7. The method of claim 1, wherein the data describing the webpage includes a screenshot of the webpage and HTML (Hypertext Markup Language) code of the webpage.

8. The method of claim 7, wherein accessing the webpage data comprises:
receiving a seed URL (Uniform Resource Locator) of the webpage;
generating the screenshot of the webpage based on the seed URL; and
retrieving the HTML code of the webpage based on the seed URL.

9. The method of claim 7, further comprising preprocessing the HTML code to remove metadata.

10. One or more non-transitory computer-readable storage mediums storing instructions that, when executed by a computer system, causes the computer system to perform operations comprising:
accessing webpage data describing a webpage, wherein the webpage comprises target content;
generating, by a content analysis agent, a first prompt comprising the webpage data and instructions for a first LLM (large language model) to:
analyze the webpage data describing the webpage to determine a structure of the webpage and to identify target content of the webpage; and
generate first output describing the determined structure of the webpage and the identified target content;
inputting the first prompt to the first LLM;
receiving, from the first LLM, the first output describing the determined structure of the webpage and the identified target content;
generating, by a code generation agent, a second prompt comprising the first output and instructions for a second LLM to, based on the first output, generate a script that, when executed, extracts the identified target content of the webpage;
inputting the second prompt to the second LLM;
receiving, from the second LLM, second output including an executable script;
generating data describing the target content of the webpage by executing the script on at least a portion of the webpage data;
storing the data describing the target content of the webpage in a database;
receiving a query related to the webpage from a client device associated with a user;
accessing the data describing the target content of the webpage from the database; and
generating a response to the query based on the accessed data describing the target content of the webpage.

11. The one or more non-transitory computer-readable storage mediums of claim 10, further comprising:
generating a third prompt comprising the first output and instructions for a third LLM to:
generate an accuracy determination for the determined structure of the webpage and for the identified target content; and
responsive to the accuracy determination for the determined structure of the webpage and for the identified target content disapproving the determined structure and the identified target content, generate feedback for the first LLM;
inputting the third prompt to the third LLM; and
receiving, from the third LLM, fourth output including the accuracy determination for the determined structure of the webpage and for the identified target content and the feedback for the first LLM.

12. The one or more non-transitory computer-readable storage mediums of claim 11, further comprising:
responsive to the accuracy determination for the determined structure of the webpage and for the identified target content disapproving the determined structure and the identified target content, generating a fourth prompt comprising the feedback and instructions for the first LLM to revise the first output based on the feedback.

13. The one or more non-transitory computer-readable storage mediums of claim 10, wherein the second prompt is generated responsive to an accuracy determination from a third LLM approving the determined structure of the webpage and the identified target content from the first LLM.

14. The one or more non-transitory computer-readable storage mediums of claim 10, further comprising:
generating, by a critique agent, a third prompt comprising instructions for a third LLM to generate an accuracy determination indicating whether the executable script of the second output would, when executed, extract the target content of the webpage;
inputting the third prompt to the third LLM; and
receiving, from the third LLM, third output including the accuracy determination for the executable script,
wherein generating the data describing the target content of the webpage is performed responsive to the accuracy determination for the executable script approving the executable script of the second output.

15. The one or more non-transitory computer-readable storage mediums of claim 10, wherein the first prompt further comprises instructions from a second user describing how to identify the target content of the webpage.

16. The one or more non-transitory computer-readable storage mediums of claim 10, wherein the data describing the webpage includes a screenshot of the webpage and HTML (Hypertext Markup Language) code of the webpage.

17. The one or more non-transitory computer-readable storage mediums of claim 16, wherein accessing the webpage data comprises:
receiving a seed URL (Uniform Resource Locator) of the webpage;
generating the screenshot of the webpage based on the seed URL; and
retrieving the HTML code of the webpage based on the seed URL.

18. The one or more non-transitory computer-readable storage mediums of claim 10, further comprising preprocessing the HTML code to remove metadata.

19. A computer system comprising a set of one or more processors and a computer-readable storage medium storing instructions that, when executed by the set of processors, causes the set of processors to perform operations comprising:
accessing webpage data describing a webpage, wherein the webpage comprises target content;
generating, by a content analysis agent, a first prompt comprising the webpage data and instructions for a first LLM (large language model) to:
analyze the webpage data describing the webpage to determine a structure of the webpage and to identify target content of the webpage; and
generate first output describing the determined structure of the webpage and the identified target content;
inputting the first prompt to the first LLM;
receiving, from the first LLM, the first output describing the determined structure of the webpage and the identified target content;
generating, by a code generation agent, a second prompt comprising the first output and instructions for a second LLM to, based on the first output, generate a script that, when executed, extracts the identified target content of the webpage;
inputting the second prompt to the second LLM;
receiving, from the second LLM, second output including an executable script;
generating data describing the target content of the webpage by executing the script on at least a portion of the webpage data;
storing the data describing the target content of the webpage in a database;
receiving a query related to the webpage from a client device associated with a user;
accessing the data describing the target content of the webpage from the database; and
generating a response to the query based on the accessed data describing the target content of the webpage.

20. The computer system of claim 19, wherein the operations further comprise:
generating a third prompt comprising the first output and instructions for a third LLM to:
generate an accuracy determination for the determined structure of the webpage and for the identified target content; and
responsive to the accuracy determination for the determined structure of the webpage and for the identified target content disapproving the determined structure and the identified target content, generate feedback for the first LLM;
inputting the third prompt to the third LLM; and
receiving, from the third LLM, third output including the accuracy determination for the determined structure of the webpage and for the identified target content and the feedback for the first LLM.
